(19) United States
(12) Patent Application Publication
(10) Pub. No.: US 2014/0317169 A1
(43) Pub. Date: Oct. 23, 2014

(54) METHOD, APPARATUS, AND COMPUTER PROGRAM PRODUCT FOR SERVER SIDE DATA MASHUPS SPECIFICATION

(71) Applicant: NAVTEQ B.V., Veldhoven (NL)

(72) Inventors: Kanna Shimizu, Winchester, MA (US); Balaji Rajamani, North Billerica, MA (US); (David) Ngai Lam, Woburn, MA (US)

(21) Appl. No.: 13/866,208

(22) Filed: Apr. 19, 2013

(51) Int. Cl. H04L 29/06

(52) U.S. Cl. CPC H04L 67/42
USPC 709/203

(57) ABSTRACT

A method, apparatus, and computer program product are provided in order to provide for the specification of server-side data mashups. A method is provided comprising receiving a request for data of an object type; retrieving a data model for the object type; interpreting one or more annotations specifying data to be retrieved from one or more sources to be combined with the object data; retrieving data from one or more sources based on the annotations; generating an output payload by merging the object data and the retrieved data; and causing the output payload to be returned to a client application. A corresponding apparatus and a computer program product are also provided.

### TECHNOLOGICAL FIELD

An example embodiment of the present invention relates generally to web services, and more specifically, to combining data from multiple different sources on the server-side to serve mashed-up or merged data to a client.

### BACKGROUND

The modern communications era has brought about a tremendous expansion of wireline and wireless networks. Wireless and mobile networking technologies have addressed related consumer demands, while providing more flexibility and immediacy of information transfer. Concurrent with the expansion of networking technologies, an expansion in computing power has resulted in the development of affordable computing devices capable of taking advantage of services made possible by modern networking technologies. This expansion in computing power has led to a reduction in the size of computing devices and given rise to a new generation of mobile devices that are capable of performing functionality that only a few years ago required processing power that could be provided only by the most advanced desktop computers. Consequently, mobile computing devices having a small form factor have become ubiquitous and are used to access network applications and services by consumers of most all socioeconomic backgrounds.

Many computing devices, such as mobile terminals, cellular telephones, smart phones, tablet computers, personal digital assistants, or the like, provide access to multiple applications which may rely on processing provided by, and/or data stored at, remote networks and devices. Such applications may individually store a multitude of user data on the remote networks with each of the applications possibly storing some part of the user data that is the same or similar, such as user profile data. When a user updates this stored data using one application, those same updates may need to be made to the stored data in all of the other applications storing the same or similar data. However, maintaining the same data for multiple different applications becomes time consuming and the data presented in one application may become inconsistent with data presented by another application.

### BRIEF SUMMARY

Embodiments of the present invention relate to combining data from multiple sources on a server-side before presenting the combined data to a client. Embodiments may provide for specification of properties in a data model and source the data for these properties from multiple different data sources.

Embodiments may provide for a seamless experience for a user between applications by combing data sourced from two or more applications on the server-side before presenting the output data in an application to the user.

A method, apparatus and computer program product are therefore provided according to an example embodiment of the present invention to provide for the specification of server-side data mashups in a data model.

In one embodiment, a method is provided that at least includes receiving a request for data of an object type; retrieving a data model for the object type; interpreting one or more annotations specifying data to be retrieved from one or more sources to be combined with the object data; retrieving data from one or more sources based on the annotations; generating an output payload by merging the object data and the retrieved data; and causing the output payload to be returned to a client application.

In some example embodiments, the one or more sources for data may comprise data of one or more applications different from the requesting client application. In some example embodiments, a top level data model attribute may be provided to list the one or more properties of the data model that are to be retrieved from the one or more sources. In some example embodiments, the annotations in the data model may be specified using a computed property data model attribute.

In some example embodiments, the output payload of merged data may be generated based on a single server call from the client application. In some example embodiments, the data model may be specified using JavaScript Object Notation.

In another embodiment, an apparatus is provided comprising at least one processor and at least one memory including computer program instructions, the at least one memory and the computer program instructions configured to, with the at least one processor, cause the apparatus at least to: receive a request for data of an object type; retrieve a data model for the object type; interpret one or more annotations specifying data to be retrieved from one or more sources to be combined with the object data; retrieve data from one or more sources based on the annotations; generate an output payload by merging the object data and the retrieved data; and cause the output payload to be returned to a client application.

In a further embodiment, a computer program product is provided comprising at least one non-transitory computer-readable storage medium bearing computer program instructions embodied therein for use with a computer, the computer program instructions comprising program instructions configured to: receive a request for data of an object type; retrieve a data model for the object type; interpret one or more annotations specifying data to be retrieved from one or more sources to be combined with the object data; retrieve data from one or more sources based on the annotations; generate an output payload by merging the object data and the retrieved data; and cause the output payload to be returned to a client application.

In another embodiment, an apparatus is provided comprising means for receiving a request for data of an object type; means for retrieving a data model for the object type; means for interpreting one or more annotations specifying data to be retrieved from one or more sources to be combined with the object data; means for retrieving data from one or more sources based on the annotations; means for generating an output payload by merging the object data and the retrieved data; and means for causing the output payload to be returned to a client application.

### BRIEF DESCRIPTION OF THE DRAWINGS

Having thus described certain embodiments of the invention in general terms, reference will now be made to the accompanying drawings, which are not necessarily drawn to scale, and wherein:

FIG. 1 illustrates an example data model for an object in accordance with an example embodiment of the present invention;

FIG. 2 illustrates example data model attributes for specifying server-side data mashups in accordance with an example embodiment of the present invention;

FIG. 3 is a flow chart illustrating operations for providing server-side data mashups in accordance with an example embodiment of the present invention;

FIG. 4 is a flow chart illustrating operations for providing annotations in a data model in accordance with an example embodiment of the present invention;

FIG. 5 illustrates an example operation flow for creating or updating data for an object type using a data model in accordance with an example embodiment of the present invention;

FIG. 6 provides an exemplary block diagram illustrating components and operations for creating or updating data for an object type using a data model in accordance with an example embodiment of the present invention;

FIG. 7 provides an exemplary block diagram illustrating components and operations for updating the index in accordance with an example embodiment of the present invention;

FIG. 8 illustrates an example request for a data object using access controls in accordance with an example embodiment of the present invention; and

FIG. 9 is a block diagram of an apparatus that may be specifically configured in accordance with an example embodiment of the present invention.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory physical storage medium (e.g., volatile or non-volatile memory device), can be differentiated from a “computer-readable transmission medium,” which refers to an electromagnetic signal.

A method, apparatus and computer program product are provided in accordance with an example embodiment of the present invention to provide for the specification of server-side data mashups in a data model.

Embodiments may provide end users with a seamless experience across applications by sourcing data from two or more applications which is combined on the server-side to serve “mashed-up” or “merged” data to the calling client application. For example, in some embodiments, a user may create a profile thorough one application and then create a restaurant review through another application. When the second application renders the restaurant review for viewing, the restaurant review may include the nickname and photo from the profile created in the first application.

Embodiments may allow the profile data to be seamlessly provided across the two applications without the user having to create the profile data twice (i.e., creating the profile data in each application) and may also allow for changes made to the profile data in one application by the user to be automatically reflected in any instance where the profile data is rendered (i.e., the profile data is kept normalized while appearing in multiple different applications). For example, if a user changes the display name or nickname in their profile in the first application, since the data from the two applications is combined upon a request from the client (e.g., the data is combined on the fly), the updated profile name will always be retrieved for display with the restaurant review of the second application.

In some embodiments, an application developer may specify properties or attributes in a data model where the data for the specified properties or attributes may be sourced from different data models (e.g., from different data stores or tables, etc.). For example, in some embodiments, an application developer may be able to specify these properties in a JavaScript Object Notation (JSON) file using simple syntax without having to write any code. In some embodiments, a schema file that represents the data model of an object is annotated with the location where the value for the property or attribute should be retrieved from, such as a data store or different object.

In some embodiments, since the data model schema file contains the annotations for where data is to be sourced from, a change in a data source (e.g., a new source type is introduced) only requires a simple change in the data model file. No data migration or schema update is required to reflect the update in the data source.

In some embodiments, when a request for an object is made to the server by a client application, the server may interpret the annotations in the data model of the object and retrieve the data from the source referred to in the annotation. The server may extract the values from the data and populate the appropriate fields of the data model before the object payload is returned to the client application.

Embodiments may allow for the combination of data from several sources without the client application having to make repeated calls to the data server by the client. Instead, the server combines the data before it is served to the client application as a result of a call from the client application.

In some embodiments, data models may be created to model objects within an application. The data model of an object type provides for a structure to be used in storing and rendering data for an application. A data model may be created comprising a number of properties which represent one or more fields or values for the object type. In some embodiments, a data model may be created using a JSON schema file, for example.

In some embodiments, a data model may also indicate access controls for the object, such as to allow everyone read access to an object and/or limit write access to an object to the creator of the data. In some embodiments, indices may be defined for the data model to support queries on the object type.

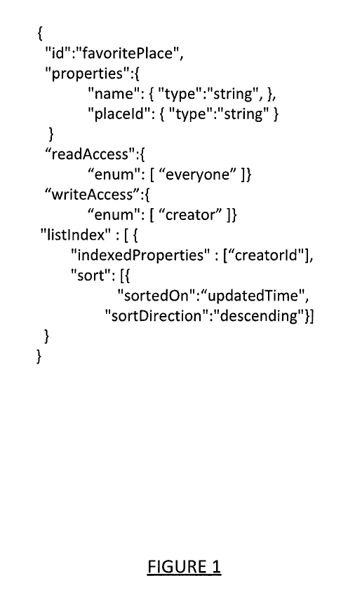

FIG. 1 illustrates an example data model written using a JSON schema in accordance with some embodiments. FIG. 1 illustrates a data model that represents a favorite places object type used in an application. The example data model is for a “favoritePlace” type and comprises two properties, a “name” property and a “placeId” property. As illustrated in FIG. 1, the example data model comprises access control settings specifying that readAccess is set to “everyone” such that anyone may view the object data and writeAccess is set to “creator” such that only the data creator may modify the object data. FIG. 1 further illustrates that the example data model specifies indices as to how the data should be stored and/or ordered in response to a query. The example data model indicates that the “favoritePlace” type data should be indexed by “creatorId” and should be sorted in descending order by “updatedTime”.

In an example embodiment of the present invention, a schema file, such as a JSON schema file, that represents the data model of an object type may be annotated with the location where one or more values should be retrieved from to populate certain properties of the data model. For example, a JSON data model for “reviews” may indicate that the value of the property “name” should be retrieved from the object of type “socialUser” having the “id” value the same as this object's “creatorId” field. And, the data model annotation further specifies that within that “socialUser” object, the value that is in the field “displayName” should be used to populate the “name” property of the “review” payload that is to be returned to the client.

```
{
  “id”;“reviews”,
  “properties” : {
      ...,
      “name” : {
        ...,
        “computeFrom” : {
          “type” : “socialUser”,
          “id” : “this-creatorId”,
          “field” : “displayName”
        },
        ...
    }
    ...
}
```

When a client issues a read request to the server for a “review” written by a user Alice, the server interprets the annotations in the “review” data model, retrieves the “socialUser” data created by Alice, and then extracts the “displayName” value from the “socialUser” data to populate the “name” field in the “review” object payload to be returned to the client. In this manner, the “review” type data and the “socialUser” type data are mashed together before they are returned to the client application in one server call.

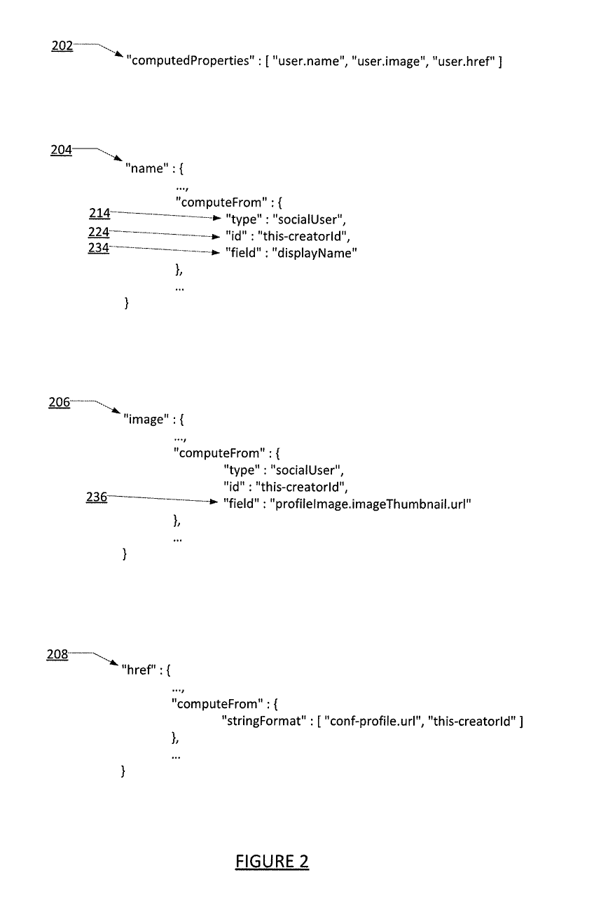

FIG. 2 illustrates some exemplary data model attributes that may be provided to specify server-side data mashups in accordance with an example embodiment. To allow for the specification of server-side data mashups in a data model of an object, first a new top-level data model attribute, computedProperties, may be created that lists all the properties that are to be computed in the data model. For example, a data model may contain computedProperties top-level data model attribute 202 which lists that the data model may compute values for name, image, and href properties for a data model when it is requested by a client. The values for these properties may be computed during object retrieval in response to a client request. In some embodiments, when a create and/or update request is received from a client, if values for the computedProperties are included in the create/update request, the values for these properties will be deleted before the object is updated at the server.

A new data model attribute, computeFrom, may be created for each of the properties to be computed as listed in the computedProperties attribute. In some embodiments, a computeFrom attribute for a property of the data model may comprise annotations to indicate the data source that contains the data for the property and a field within that data source that contains the property value to be retrieved. For example, the value of the “name” property 204 may be retrieved from the value of the displayName property 234 of a socialUser object 214 whose id 224 matches the value of the creatorId property of the current object to be retrieved.

In some embodiments, the field property of a computeFrom attribute may allow for the specifying a nested property using dot notation, such as shown in field 236 of the “image” property 206 of the example embodiment of FIG. 2. For example, the value for the image property 206 of the object (e.g., the profile image of the user) may be retrieved from the “profileimage.imageThumbnail.url” 236 of the socialUser object whose id matches the value of the creatorId property of the current object to be retrieved.

In an example embodiment of the data model attributes as illustrated in FIG. 2, the value of the href property 208 is a string formatted with some given arguments. The annotation may be modeled after the format method of the String class, for example. The first item of the stringFormat list is the pattern for the href with placeholders of the form {n} where n starts with 0. The value of the next item in the list will substitute for the 0th placeholder; the value of the next next item will substitute for the 1st placeholder; etc. The number of placeholders and the number of substituting items should be the same. If there are more placeholders than substituting items, then the extra placeholders may remain in the resulting formatted string. If there are more substituting items than placeholders, then the extra substituting items may be ignored.

For example, if there is a property profile.url in the system configuration file and it is set to https://profiles.COMPANY.com/users/{0}, then conf-profile.url will be resolved to this value. And similarly, if the value of the creatorId property of the object to be retrieved is xxxxxxxx-xxxx-xxxx-xxxx-xxxxxxxxxxxx, then this-creatorId will be resolved to this value. Finally, in the example embodiment, the value of the href property 208 will be computed to https://profiles.COMPANY.com/users/xxxxxxxx-xxxx-xxxx-xxxx-xxxxxxxxxxxx.

In some embodiments, one level of indirection may be supported for values of the type, id, field, and stringFormat attributes of the computeFrom data model attribute, as illustrated in FIG. 2.

In the illustrated embodiment, the “this-” prefix for a property value annotation indicates that the value comes from a property of the object to be retrieved. For example, in FIG. 2, the “id”:“this-creatorId” property of the computeFrom attribute indicates that the id value for the property should be sourced from the creatorId property of the current object being retrieved (e.g., the ID of the user who created the particular object, such as a restaurant review). In the example embodiment, the “conf-” prefix for a property value annotation indicates that the value comes from a property in a system configuration file.

In some embodiments, if a property is in the computedProperties list for a data model but the property does not have the computeFrom attribute in the data model, the server may register an exception and treat it as a data model error. In some embodiments, if a property in the data model cannot be computed, its value will not be populated in the object payload returned to the client.

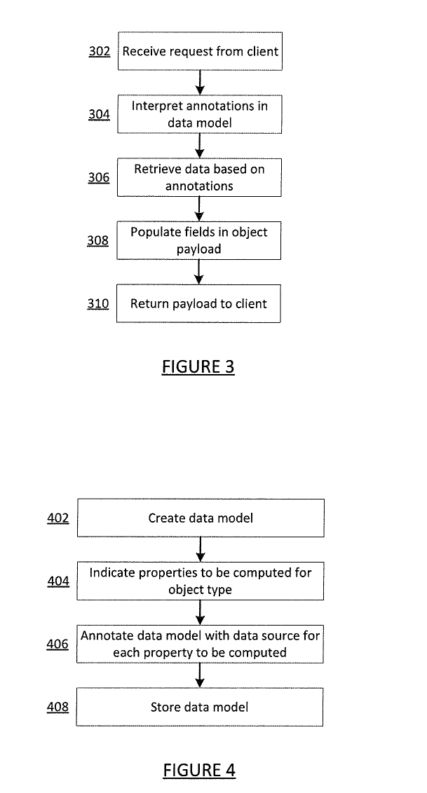

FIG. 3 is a flow chart illustrating operations for providing server-side data mashups in accordance with an example embodiment of the present invention.

In this regard, an apparatus, such as apparatus 900, may include means, such as the processor 902, memory 904, communication interface 908, or the like, for receiving a request for a data object from a client application. For example, the apparatus may receive a request to provide the restaurant reviews of a particular user. See block 302 of FIG. 3. The apparatus 900 may include means, such as the processor 902, memory 904, or the like, for determining the data model that is applicable to the client request and interpreting the annotations for server-side data mashup within the data model. See block 304 of FIG. 3.

As shown in block 306 of FIG. 3, the apparatus 900 may also include means, such as the processor 902, memory 904, or the like, for retrieving data values for the properties of the data model based on the annotations. In an example embodiment, the apparatus may retrieve values from a particular field of a different object type that is defined in an annotation of the data model for the current object. For example, the apparatus may retrieve a display name and image from a profile object type to populate a user name and image in a payload of a requested restaurant review object. The apparatus 900 may also include means, such as the processor 902, memory 904, or the like, for populating the properties within the data model with the retrieved data to generate an object payload, wherein the object payload may contain data sourced from multiple different sources (e.g., different object types from different applications). See block 308 of FIG. 3.

The apparatus 900 may also include means, such as the processor 902, memory 904, or the like, for returning the payload to the client application, such as for display to a user. See block 310 of FIG. 3.

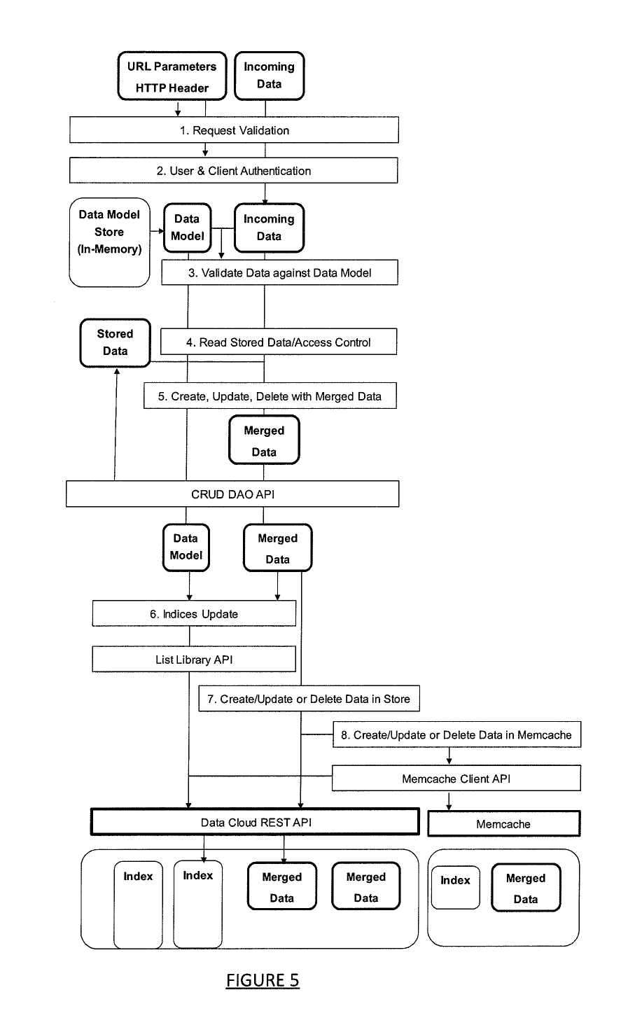

FIG. 4 is a flow chart illustrating operations for providing annotations in a data model in accordance with an example embodiment of the present invention.

In this regard, an apparatus, such as apparatus 900, may include means, such as the processor 902, memory 904, user interface 906, or the like, for creating a new data model for an application (or updating a previously defined data model). See block 402 of FIG. 4. The apparatus 900 may include means, such as the processor 902, memory 904, user interface 906, or the like, for indicating properties for the object type within the data model whose values should be sourced from one or more different sources, such as different object types of one or more other applications. See block 404 of FIG. 4. For example, in some embodiments the indication may comprise a top-level data model attribute that provides a listing of the set of properties that should be computed when a request to retrieve the object type represented by the data model is received.

As shown in block 406 of FIG. 4, the apparatus 900 may also include means, such as the processor 902, memory 904, user interface 906, or the like, for annotating the data model to specify the data source and particular values within the data source that should be used to compute the values of the properties that are to be computed for the data model. The apparatus 900 may also include means, such as the processor 902, memory 904, or the like, for storing the new (or updated) data model to be used in an application. See block 408 of FIG. 4.

FIG. 5 illustrates an example operation flow for creating or updating data for an object type using a data model in accordance with an example embodiment of the present invention. An apparatus, such as apparatus 900, may receive data and parameters from a client application. For example, a user may indicate within a client application that the user wishes to store data regarding a favorite place. In an example embodiment, the apparatus may first request validation and perform user and client authentication using the received parameters, using means such as the processor 902, memory 904, communication interface 908, or the like.

Once the user and client have been authenticated, the apparatus, using means such as the processor 902, memory 904, or the like, may retrieve a data model that should be applied to the incoming data from the client, such as from a data model store. The apparatus, using means such as the processor 902, memory 904, or the like, may validate the incoming data against the retrieved data model to verify that the incoming data conforms to the data model. For example, the apparatus may validate that the incoming data has all the expected properties specified by the data model.

The apparatus, using means such as the processor 902, memory 904, or the like, may read stored data and/or parameters, such as access control parameters, that should be merged with the incoming data, such as may be specified in the data model, for example. The apparatus may then generate merged data by combining the incoming data with the retrieved stored data and/or parameters, such as by creating, updating, or deleting data to generate the merged data, using means such as the processor 902, memory 904, or the like.

The apparatus, using means such as the processor 902, memory 904, or the like, may then update one or more indices based on specification in the data model and the merged data and update a list layer persistence layer, such as by updating index keys or the like. The apparatus, using means such as the processor 902, memory 904, or the like, may then create, update, or delete data in a data store based on the merged data. The apparatus, using means such as the processor 902, memory 904, or the like, may also provide instructions to create, update, or delete data in the memory cache of the client based on the merged data.

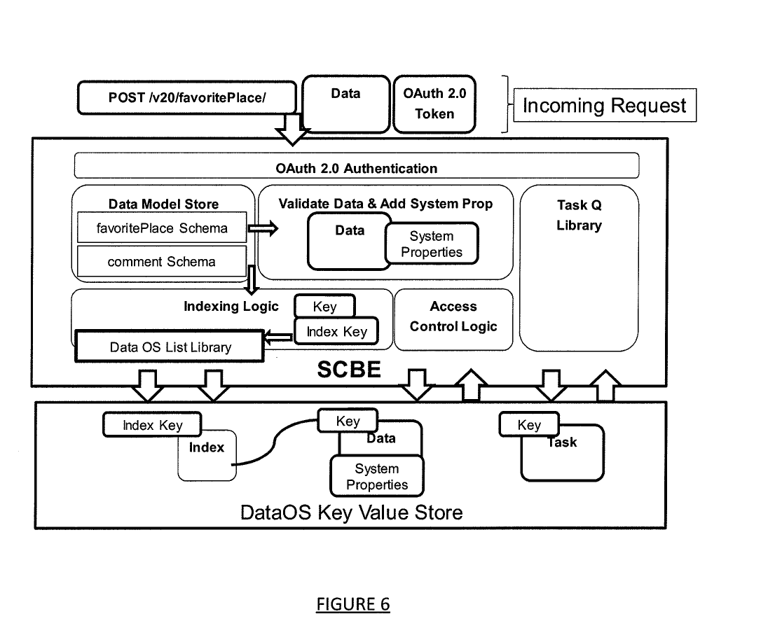

FIG. 6 provides an exemplary block diagram illustrating components and operations for creating or updating data for an object type using a data model in accordance with an example embodiment of the present invention, and as also described in regard to FIG. 5 above.

As illustrated in FIG. 6, an apparatus may receive an incoming request to post (e.g. store) user data as a favorite place object type. In an example embodiment, the incoming request may comprise a POST command indicating the object type “favoritePlace”, the data describing the favorite place, and authentication data for the user and client.

In an example embodiment, the apparatus may first authenticate the user and client. The apparatus may then retrieve a data model, such as from a data model store, to validate the incoming data and add system properties to the incoming data, such as access controls. The apparatus may then use the data model and the data to generate a key for the data and calculate and index key, such as by using indexing logic. The apparatus may use a list library to update the list layer persistence layer with the data key and index key. The apparatus may then update an index using the index key and referring to the data by using the data key.

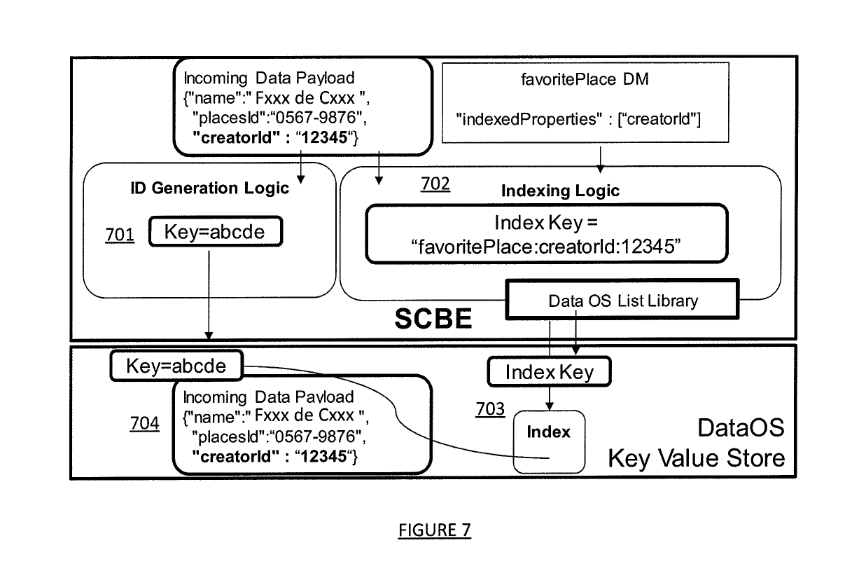

FIG. 7 provides an exemplary block diagram illustrating components and operations for updating the index in accordance with an example embodiment of the present invention, and as described in regard to FIG. 6 above. In an example embodiment, as shown at 701, the apparatus may receive the incoming data and generate an identifier (e.g., a key) for the incoming data, such as key “abcde”. The apparatus may use the incoming data and the data model to calculate an index key, as shown at 702. For example, the apparatus may use the incoming data and the favoritePlace data model to calculate the index key. The favoritePlace data model may define that data associated with the data model should be indexed based on the creator of the data, such as by specifying an indexedProperties value of “creatorId”. The apparatus may then update the index using the index key and the key for the data, as shown at 703. The apparatus may then store the data with the new key, as shown at 704.

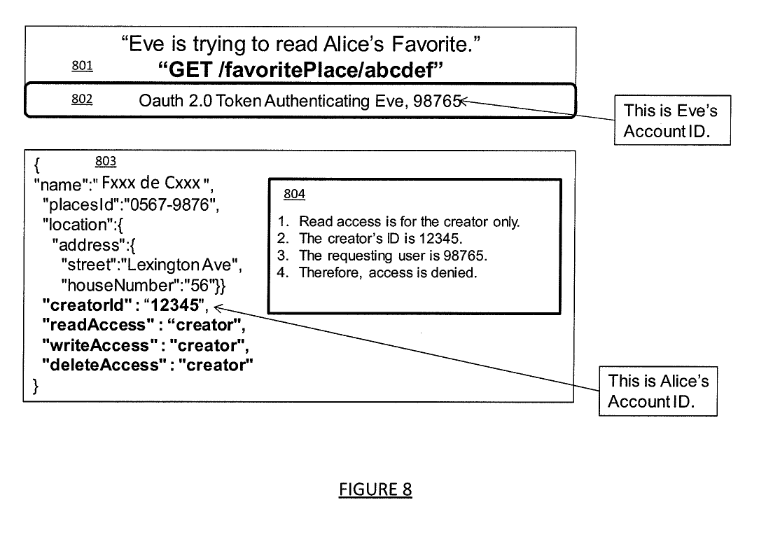

FIG. 8 illustrates an example request for a data object using access controls in accordance with an example embodiment of the present invention. In an example embodiment, as illustrated at 801, a request is generated to read (e.g., GET) favorite data at a client application. For, example, a user Eve request to retrieve favorite place data for “abcdef” that was created by a user Alice. Included with the request from the client is an authentication token 802 identifying the user making the request as Eve, “98765”. The apparatus may retrieve the stored data 803 associated with the favorite place “abcdef” As shown at 804, the apparatus may determine the read access value for the stored data 803 as being creator only and compare the creator ID for the stored data 803 with the requesting user ID. As shown, in 804, since the requesting user ID does not match the creator ID, the read request would be denied.

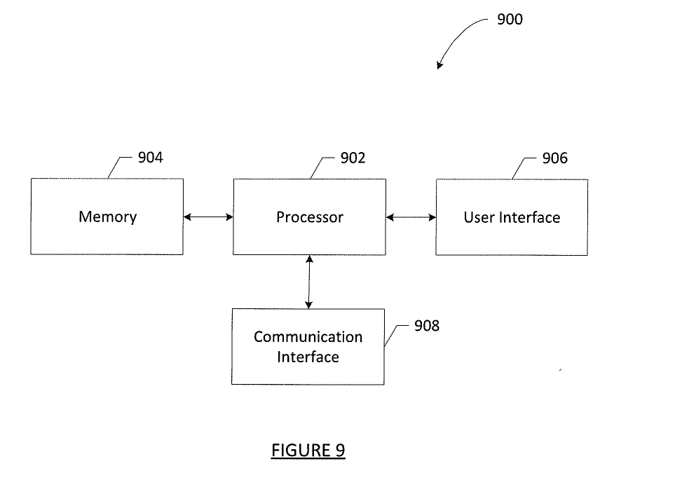

The system of an embodiment of the present invention may include an apparatus 900 as generally described below in conjunction with FIG. 9 for performing one or more of the operations set forth by FIGS. 3 through 8 described above. In this regard, the apparatus may be embodied by a computing device such as a personal computer, a mobile device, a mobile phone, a smartphone, a personal digital assistant, a tablet computer, or the like.

It should also be noted that while FIG. 9 illustrates one example of a configuration of an apparatus 900 for providing specification of server-side data mashups, numerous other configurations may also be used to implement other embodiments of the present invention. As such, in some embodiments, although devices or elements are shown as being in communication with each other, hereinafter such devices or elements should be considered to be capable of being embodied within the same device or element and thus, devices or elements shown in communication should be understood to alternatively be portions of the same device or element.

Referring now to FIG. 9, an apparatus 900 for providing specification of server-side data mashups in accordance with an example embodiment may include or otherwise be in communication with one or more of a processor 902, a memory 904, a user interface 906, and a communication interface 908.

In some embodiments, the processor (and/or co-processors or any other processing circuitry assisting or otherwise associated with the processor) may be in communication with the memory 904 via a bus for passing information among components of the apparatus. The memory device 904 may include, for example, a non-transitory memory, such as one or more volatile and/or non-volatile memories. In other words, for example, the memory 904 may be an electronic storage device (e.g., a computer readable storage medium) comprising gates configured to store data (e.g., bits) that may be retrievable by a machine (e.g., a computing device like the processor). The memory 904 may be configured to store information, data, content, applications, instructions, or the like for enabling the apparatus to carry out various functions in accordance with an example embodiment of the present invention. For example, the memory 904 could be configured to buffer input data for processing by the processor 902. Additionally or alternatively, the memory 904 could be configured to store instructions for execution by the processor.

In some embodiments, the apparatus 900 may be embodied as a chip or chip set. In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present invention on a single chip or as a single “system on a chip.” As such, in some cases, a chip or chipset may constitute means for performing one or more operations for providing the functionalities described herein.

The processor 902 may be embodied in a number of different ways. For example, the processor may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining and/or multithreading.

In an example embodiment, the processor 902 may be configured to execute instructions stored in the memory 904 or otherwise accessible to the processor. Alternatively or additionally, the processor may be configured to execute hard coded functionality. As such, whether configured by hardware or software methods, or by a combination thereof, the processor may represent an entity (e.g., physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device configured to employ an embodiment of the present invention by further configuration of the processor by instructions for performing the algorithms and/or operations described herein. The processor may include, among other things, a clock, an arithmetic logic unit (ALU) and logic gates configured to support operation of the processor.

The apparatus 900 may include a user interface 906 that may, in turn, be in communication with the processor 902 to provide output to the user and, in some embodiments, to receive an indication of a user input. For example, the user interface may include a display and, in some embodiments, may also include a keyboard, a mouse, a joystick, a touch screen, touch areas, soft keys, a microphone, a speaker, or other input/output mechanisms. The processor may comprise user interface circuitry configured to control at least some functions of one or more user interface elements such as a display and, in some embodiments, a speaker, ringer, microphone and/or the like. The processor and/or user interface circuitry comprising the processor may be configured to control one or more functions of one or more user interface elements through computer program instructions (e.g., software and/or firmware) stored on a memory accessible to the processor (e.g., memory 904, and/or the like).

The apparatus 900 may optionally include a communication interface 908 which may be any means such as a device or circuitry embodied in either hardware or a combination of hardware and software that is configured to receive and/or transmit data from/to a network and/or any other device or module in communication with the apparatus 900. In this regard, the communication interface may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware/software for supporting communication via cable, digital subscriber line (DSL), universal serial bus (USB), WiFi, Bluetooth, or other mechanisms.

Accordingly, blocks of the flowchart support combinations of means for performing the specified functions and combinations of operations for performing the specified functions for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included, such as shown by the blocks with dashed outlines. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
receiving a request for data of an object type;
retrieving a data model for the object type;
interpreting one or more annotations specifying data to be retrieved from one or more sources to be combined with the object data;
retrieving data from one or more sources based on the annotations;
generating an output payload by merging the object data and the retrieved data; and
causing the output payload to be returned to a client application.

2. The method of claim 1, wherein the one or more sources for data comprise data of one or more applications different from a requesting client application.

3. The method of claim 1, wherein a top level data model attribute is provided to list the one or more properties of the data model that are to be retrieved from the one or more sources.

4. The method of claim 1, wherein annotations in the data model are specified using a computed property data model attribute.

5. The method of claim 1, wherein the data model is specified using javascript object notation.

6. The method of claim 1, wherein the output payload of merged data is generated based on a single server call from the client application.

7. An apparatus comprising at least one processor and at least one memory including computer program instructions, the at least one memory and the computer program instructions configured to, with the at least one processor, cause the apparatus at least to:
receive a request for data of an object type;
retrieve a data model for the object type;
interpret one or more annotations specifying data to be retrieved from one or more sources to be combined with the object data;
retrieve data from one or more sources based on the annotations;
generate an output payload combing the object data and the retrieved data; and
cause the output payload to be returned to a client application.

8. The apparatus of claim 7, wherein the one or more sources for data comprise data of one or more applications different from a requesting client application.

9. The apparatus of claim 7, wherein a top level data model attribute is provided to list the one or more properties of the data model that are to be retrieved from the one or more sources.

10. The apparatus of claim 7, wherein annotations in the data model are specified using a computed property data model attribute.

11. The apparatus of claim 7, wherein the data model is specified using javascript object notation.

12. The apparatus of claim 7, wherein output payload of merged data is generated based on a single server call from the client application.

13. A computer program product comprising at least one non-transitory computer-readable storage medium bearing computer program instructions embodied therein for use with a computer, the computer program instructions comprising program instructions configured to:
receive a request for data of an object type;
retrieve a data model for the object type;
interpret one or more annotations specifying data to be retrieved from one or more sources to be combined with the object data;
retrieve data from one or more sources based on the annotations;
generate an output payload combing the object data and the retrieved data; and
cause the output payload to be returned to a client application.

14. The computer program product of claim 13, wherein the one or more sources for data comprise data of one or more applications different from a requesting client application.

15. The computer program product of claim 13, wherein a top level data model attribute is provided to list the one or more properties of the data model that are to be retrieved from the one or more sources.

16. The computer program product of claim 13, wherein annotations in the data model are specified using a computed property data model attribute.

17. The computer program product of claim 13, wherein the data model is specified using javascript object notation.

18. The computer program product of claim 13, wherein output payload of merged data is generated based on a single server call from the client application.

19. An apparatus comprising:
means for receiving a request for data of an object type;
means for retrieving a data model for the object type;
means for interpreting one or more annotations specifying data to be retrieved from one or more sources to be combined with the object data;
means for retrieving data from one or more sources based on the annotations;
means for generating an output payload combing the object data and the retrieved data; and
means for causing the output payload to be returned to a client application.

20. The apparatus of claim 19, wherein the one or more sources for data comprise data of one or more applications different from a requesting client application.
